(19) United States
(12) Patent Application Publication
(10) Pub. No.: US 2016/0311615 A1
(43) Pub. Date: Oct. 27, 2016

(54) Recycling Container

(71) Applicant: Carl Fahrenkrug, Manlius, NY (US)

(72) Inventor: Carl Fahrenkrug, Manlius, NY (US)

(21) Appl. No.: 15/098,264

(22) Filed: Apr. 13, 2016

Related U.S. Application Data
(60) Provisional application No. 62/146,475, filed on Apr. 13, 2015.

(51) Int. Cl. B65F 1/14; B65F 1/16; B65F 1/02

(52) U.S. Cl. CPC B65F 1/1484; B65F 1/02; B65F 1/16; B65F 2220/128; B65F 2250/111

(57) ABSTRACT

A recycling container construction where vertical side panels protect the contents access from the vertical planes and from weather, and provide for additional rigidity to the overall structure, and transparency to view the contents of the surrounded three dimensional space is provided. The construction provides a top section and a base pan as part of the bottom portion that seals and prevents unwanted access.

### CROSS REFERENCE TO RELATED APPLICATION

Provisional Patent 62146475 Apr. 13, 2015 Fahrenkrug

### STATEMENT REGARDING FEDERALLY SPONSORED RESEARCH OR DEVELOPMENT

Not Applicable.

### STATEMENT REGARDING PRIOR DISCLOSURES BY THE INVENTOR OR A JOINT INVENTOR

Not Applicable

### BACKGROUND OF THE INVENTION

1. Technical Field

This invention relates to recycling containers

2. Background Art

Cited US Patent Documents

| | | |
|---|---|---|
| 2,125,122 | July 1938 | Mongiello |
| 3,451,582 | June 1969 | Morgan |
| 3,866,824 | February 1975 | Lewis |
| 5,360,189 | November 1994 | Hart |
| 6,241,115 B1 | June 2001 | Delmerico |
| 7,198,166 B2 | April 2007 | Sholinder |
| 7,624,915 B2 | December 2009 | Dembowiak |

Options for recycling containers that allow visibility of its contents available currently include very simple, inexpensive and portable models as in FIG. 4—unit types 1 and 2; more complicated and expensive and somewhat less portable units as shown in FIG. 4—unit type 3, and much more complicated and expensive units like in FIG. 4—unit type 4-6 which are not readily portable.

Each of these options forces the user and the producer to make the following tradeoffs:

1. Visibility of the contents

2. Protection of contents from weather and use

3. Security of the recycling materials/contents

4. Long term Rigidity and durability of the unit from weather and use or general use or abuse

5. Simplicity of assembly for the user or producer

6. Cost to design and manufacture the parts and the product

7. Ultimately the cost to the user

The models shown in FIG. 4—unit types 1 and 2 have excellent visibility of the contents, and are very low cost, are easy to assemble but are not ideal for applications for continuous long term use because they have poor structural rigidity. FIG. 4—Unit type 1 does protect the contents from weather while in FIG. 4—unit type 2 does not do so at all. Neither one of them does anything to address the security of the contents either. To the manufacturer, obviously the cost to produce are pretty low although there is specialized tooling required to form the parts. These tradeoffs make these units best for temporary use were lowest cost is important, and for areas where weather and tampering of the contents are not important factors.

The next design shown in FIG. 4 unit type 3 is more robust than FIG. 4 unit types 1 or 2 with regard to securing its contents, but is at a higher expense. While the design does show its contents, it is less visible than the prior two designs because the wire mesh interferes with visibility. While better than unit types 1 and 2 shown in FIG. 4, tampering with the contents is possible and weather protection is still very limited. Also, due to the nature of the assembly, it is not very rigid and this type of unit, design and manufacturing is more costly than the prior designs. Assembly for the user is more complicated although would probably still be considered relatively simple. The tradeoffs here limit this design to moderate levels of duty where security is somewhat important and relatively long periods of use are required.

FIG. 4—unit type 4 is similar to FIG. 4—unit type 3 but improves upon protecting and securing its contents but with significant reduction of visibility of the contents, at a much higher unit cost, and more complexity for the user or producer to assemble the product. The cost to design the product is also much higher, and the manufacturing cost will be relatively high as well, and specialized specific to this product. The rigidity is improved substantially but the assembly requires the use of hardware. This requires the assembler to be able assemble and line up the holes, and then install the hardware, which may work loose. Also, it is general practice in the industry that units like this are sent to the customer preassembled.

FIG. 4—unit type 5 uses a channel cutout in the plastic/polymer components for putting a clear panel for protecting its contents while maintaining visibility to its recycling contents. This unit can provide good protection from weather and from intrusion on the contents from the side. Like unit type 4, the unit is moderately rigid and durable and likewise is held together by hardware or specialized components. Development (design) costs and manufacturing costs are much higher than the other unit types (1-4). Also, it is general practice in the industry that units like this are sent to the customer prefabricated.

FIG. 4—unit type 6 conceptually is very similar to unit type 5, in that it uses a channel to capture the panels. In this case the panels and structure are made of polycarbonate which use forming and other specialized processes that are very expensive and only cost effective in the highest of production volumes. The units are fairly rigid and the components of this type snap together or use hardware or specialized components, or a combination of both.

In general, for the “enclosed” units (some variations of unit type 3, and unit types 4-6), hardware is used and is the key to the “part to part” structural strength and rigidity and of the overall units themselves, and/or “snap together” and other specialize hardware/components are used. Hardware usage in general requires holes, hardware, tooling, and the alignment usually of multiple components at the same time to properly fit the pieces together. Further, even with the typical use of locking hardware (split lock washers, inner and outer star washers, etc), fasteners tend to become loose and may even corrode. These fastener solutions also concentrates stress forces (caused by the use environment such as wind or weather or people pushing, leaning sitting or placing objects on the units) applied to the unit at the hardware or joints of the assemblies. This causes wearing out of the components or rounds out or strips threaded holes, or weakens the components that hold the units together at the joints.

The recycling container disclosed in U.S. Pat. No. 7,198,166 is a typical recycling container design modified for a new application. In this case the design adds an aperture to the side panels to provide visibility for inspecting the recycling container contents. While this provides some visibility to the contents, the remaining construction substantially obscures the view requiring a close proximity to inspect the contents.

The number of parts for the design is still quite complex, difficult to assemble, and costly to manufacture. The components' proprietary nature also further adds to the cost to manufacture this recycling container. The recycling container is constructed including an internal structure as means to collect recycled materials in addition to the external structure. This extra internal device adds cost and complexity to the recycling container.

The design requires mechanical hardware (such as screws and bolts) which are unreliable, tend to come loose, concentrate structural forces at said hardware locations and prone to stripping or corrosion due to wear and use in the environment.

The recycling container disclosed in U.S. Pat. No. 3,866,824 is similar to U.S. Pat. No. 7,198,166 in cost, complexity and restricted view. This design provides a means for advertising on the recycling container. This addition requires yet more hardware, complexity and cost.

Therefore it is a primary objective of the present invention to greatly simplify the means to produce and assemble a recycling container while preserving the features of visibility, robustness and performance.

It is a further objective of the invention to provide greater visibility of the contents allowing inspection from a significant distance from the recycling container.

It is a further objective of the invention to provide a recycling container wherein signage or other displayable can be added without additional hardware, fasteners or complexity.

In accordance with the present invention, a recycling container in its simplest form may contain five different parts: corner connectors, vertical frame poles, horizontal frame poles for the top and bottom frame structure, panels, and a high friction material as a “gasket”.

There exists a need by consumers for a recycling receptacle with high visibility to its contents with protection from weather and tampering, and security of the contents placed in the unit, with long term rigidity and durability by eliminating the hardware/joint design weakness, simplicity and ease of assembly with minimal use of tooling and hardware, at a reduced cost compared to the higher end units (FIG. 4 unit types 5 and 6). To make this available to consumers, producers need a low cost means for designing and manufacturing of the product. Design and manufacturing is straight forward requiring general equipment (saws, mills, other CNC or non CNC type of tooling) versus highly specialized costly equipment and tooling that is often product or part specific, and use readily available parts and materials that eliminates or minimizes design, manufacturing, or R&D costs.

The present invention shown is a recycling receptacle which has the following benefits

1. Maximizes visibility of the contents by using clear panels and a slim yet strong frame.

2. Contents are protected by polycarbonate panels or similar clear panels which are securely contained in the channel in the structure of the frame.

3. Rigidity and shock absorption is created by using strong materials which use a high friction created by the gasket material inserted between the panels and frame structure.

4. Simplicity of assembly is achieved by eliminating hardware or specialized connectors, and using readily available corner connectors that can be pressed or hammered into place with a common rubber mallet or framers clamp. Panels simply drop into place within the track of the frame, and the gasket/glazing can be installed with ones fingers or a straight edge.

5. Design and manufacturing costs are minimized by using common architectural aluminum, corner connectors, and flat rectangular pieces of polycarbonate materials, and readily available gasket material. Tools for cutting and mitering aluminum are common and basic and readily available. The same is true for cutting polycarbonate panels.

6. Design allows for shipment in a disassembled state—further reducing cost to deliver the product to the consumer.

7. Customized sizes and shapes are readily achievable at minimum incremental cost.

8. Extreme ruggedized versions are readily achievable at minimum incremental cost.

9. Units are easily adapted to other applications, customized signage or repaired through simple replacement of side panels

### BRIEF SUMMARY OF THE INVENTION

The present invention provides an optimal solution that maximizes visibility of the contents, while creating a rigid, durable, shock absorbing structure at minimal cost, where prior solutions required a consumer and manufacturer to compromise on these factors. The present invention solves these compromises by using high friction gasket material inserted between panels and frame structure, without use of hardware or proprietary components or materials, or specialized tools to assembly or manufacture the present invention.

### BRIEF DESCRIPTION OF THE SEVERAL VIEWS OF THE DRAWING

FIG. 1 is an Isometric view of the preferred construction of the present invention in which the above advantages and features are clearly disclosed as well as others which will be readily understood from the following description of the illustrated embodiment.

FIG. 2 is an isometric view of one example of other alternative constructions of a recycling center in accordance with the present invention.

FIG. 3 is a cross-sectional views where the top most view depicts the preferred location of the gasket materials for the preferred embodiment of the invention. The other views show alternative constructions of the embodiment in accordance with the present invention.

### DETAILED DESCRIPTION OF THE INVENTION

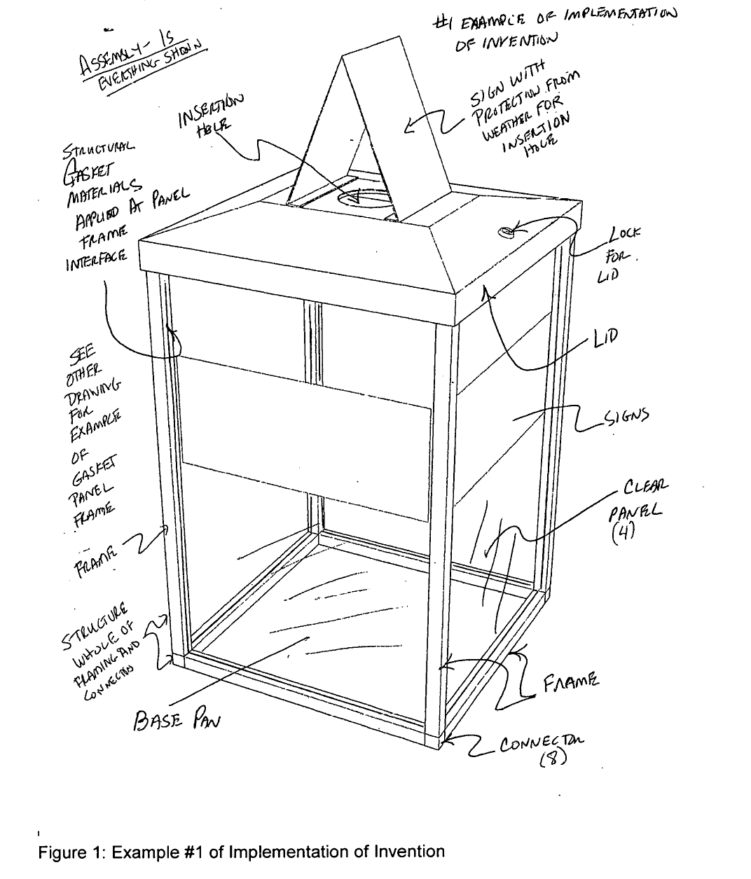

A recycling center in accordance with the present invention is generally portrayed in FIG. 1. In FIG. 1, the assembly (referred to as “assembly”) consists of a triangular top sign (referred to as “sign”); a lid (referred to as “lid”) with two cam locks (referred to as “lock for lid” of which one is on the hidden backside top surface of lid which is not fully visible) and a single hole opening (referred to as “insertion hole”) for depositing recyclables; four clear panels (referred to as “clear panel”); a structure (referred to as “structure whole of framing and connectors”) consisting of eight three-way high durometer corner connectors (referred to as “connectors” of which four are obscured by the lid and are not visible) that connect each of the 12 metal frame tubes (referred to as “frame” and where the top of the frame is obscured by the lid) together. The frame consists of 12 metal frame tubes (referred to as (“frame”) with four not visible under the lid each with u-channel shaped flanging for capturing the clear panel and high friction gasket materials. Referencing FIG. 1, the base of the recycling center consists of four identical metal frame tubes where the four frame tubes are connected together by a high durometer three-way corner connector being inserted into each of the frame tubes. Once assembled, the base frame of the structure forms a square. An identical such assembled frame-connector square (which is not shown since it is obscured by the lid) is the top of the structure. The top and bottom assembled frame-connector squares are connected to four identical vertical frame tubes, that are similar to the base frame tubes except that they are longer, by inserting said tubes onto the heretofore unused flanged of the three way corner connectors. The assembled whole of the framing and connectors constitutes the said “structure” but the top part of the structure (frame-connector square) is not installed until the panels are inserted into the u-channel first. Each panel consists of an inside and an outside. The outside of the panel faces the outside of the recycling container and the inside of the panel faces the inside of the recycling container. On the outside perimeter of each of the four panels, a high friction gasket material is applied to each of the four panels to their entire outside perimeter where it will contact the inside face of the u-channel flange that captures it. This gasket material is the width of the U-channel flange on the frame and no wider. The four panels are inserted into the U-channels of the partially assembled structure, consisting of the bottom frame-connector square and the vertical frame tubes that are connected. The top frame-connector square is then installed so that the top edge of the clear panels inserts into the u-channel part of the top frame-connector square, and the unused flange of the corner connectors are inserted into the vertical frame tubes. On the inside interface between the clear panel and the u-channel of the frame (i.e. inside the recycle container structure interior), additional high friction gasket material is inserted by pressing into the interface around the complete inside perimeter of each panel by finger or straight edge, thereby compressing all gasket materials on the inside and outside perimeter of the panel in the u-channel. A lid is on top of the said structure, and is secured to the frame of the structure by two cam locks, and lid has a triangular sign that is secured over the opening. A base pan is secured to the bottom inside edge of the flange by double sided industrial tape.

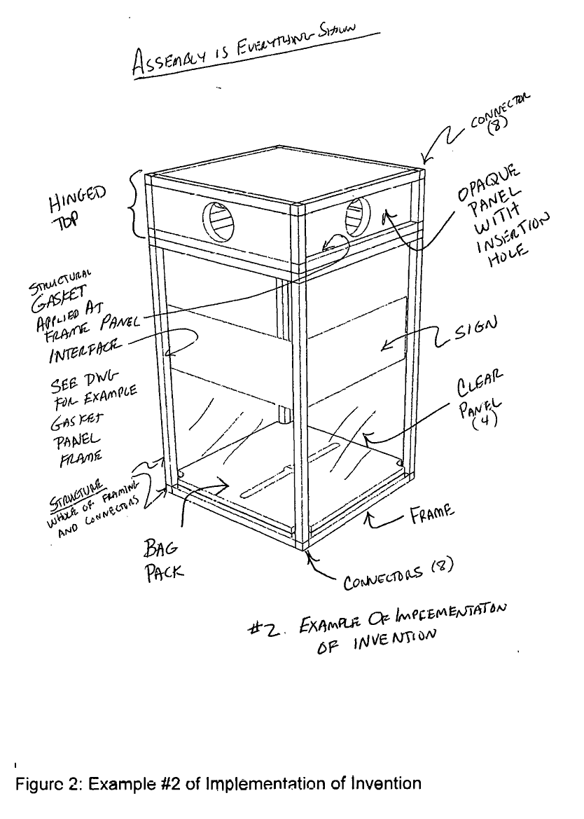

FIG. 2 depicts an alternative embodiment of a recycling center in accordance with the present invention whereby the structure and base pan is identical to that of drawing#1; the lid, lock, and sign are deleted from this construction and replaced by a top (referred to as “hinged top”) that is connected by a hinge. The hinged top is comprised of eight three-way connectors (referred to as “connector”), 4 opaque panels with an insertion hole in each panel (referred to as “opaque panel with insertion hole”) for inserting recyclables, one panel on the top side of the hinged top, and 12 frame tubes (referred to as “frame”) whereby the frame tubes are connected together with the three-way connectors in the same fashion as they were in the description for FIG. 1 and the panels, gaskets and panels assembled in the same fashion as the description of FIG. 1 with the result of the structure shown as the “hinge top” in FIG. 2.

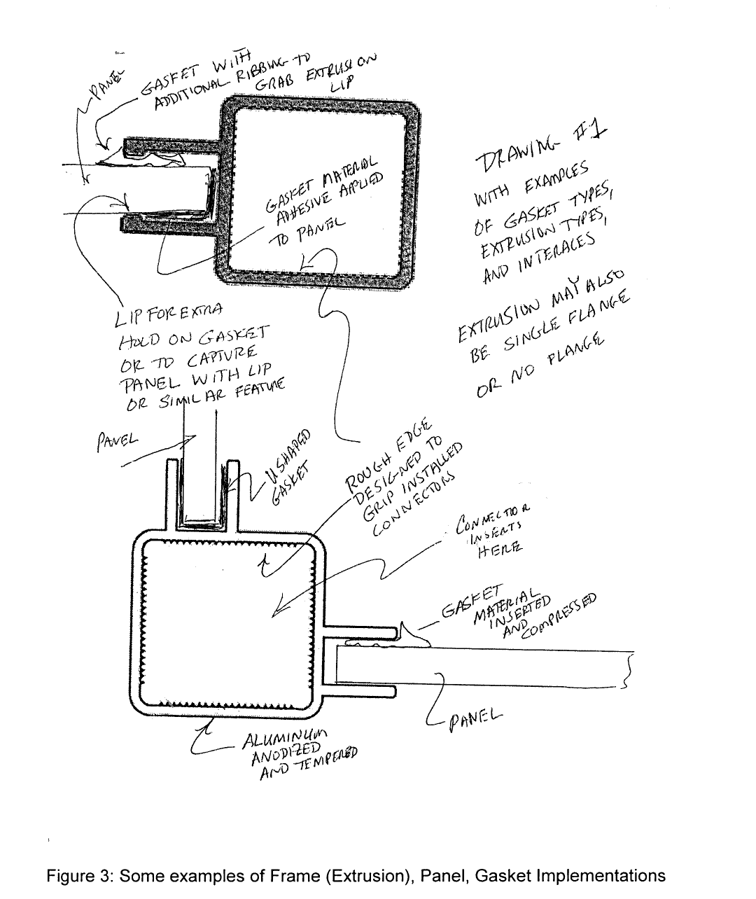

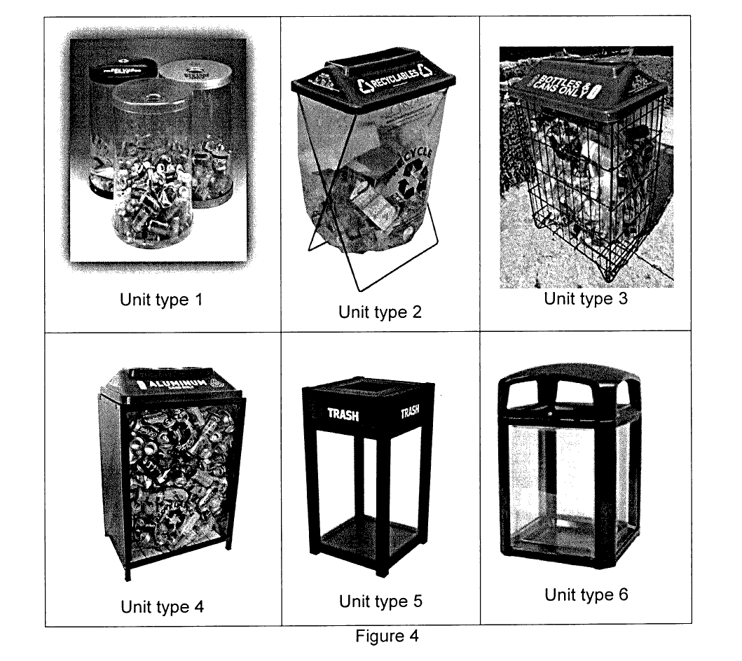

Referencing FIG. 3, the top example of a cross section view depicts the methodology used in FIG. 1 where the referenced “gasket material adhesive applied to panel” is applied to the outside perimeter of the panel before the panel is installed, and the referenced “gasket with additional ribbing to grab extrusion lip” is applied to the inside of the panel-flange interface after the panel is installed. The other examples depicted in the bottom portion of FIG. 3 shows other alternatives to the preferred embodiment referenced in FIG. 1. In one case, as shown in the bottom portion of FIG. 3, a u-channel gasket material is used, and on the second flange, only 1 gasket material is used.

From the foregoing description, it will be apparent that the invention provides a greatly improved and very advantageous recycling container construction. As will be understood by those familiar with the art, the invention may be embodied in other specific forms without departing from the spirit or essential characteristics thereof.

The invention claimed is:

1. A recycling container compromising: a frame, that in its final configuration can surrounds a three dimensional space; at least one panel, and an amount of friction material that is between said frame and at least one said panel or between a component that contains or connects said panel to said frame.

2. A recycling container of claim 1, where said friction material may be removable from said frame or said panel.

3. A recycling container of claim 1, where said friction material of claim 1 may be an adhesive, or have adhesive as a component.

4. A recycling container of claim 1, where said frame of claim 1 is constructed of metal.

5. A recycling container of claim 1, having a said frame that is composed of more than one component.

6. A recycling container of claim 1, with a said frame that contains a geometry to hold a panel such as a “U” shape.

7. A recycling container of claim 1, having a said panel that is clear or translucent.

8. A recycling container of claim 1, having a said panel that is perforated, such as a mesh.

9. A recycling container of claim 1, where a said panel is removable.

10. A recycling container of claim 1, where said panel contains signage.

11. A recycling container of claim 1, where said friction material holds a removable signage.

12. A recycling container kit compromising: a frame components, frame connectors, that in its final configuration can surrounds a three dimensional space; at least one panel, and an amount of friction material that is between said frame and at least one said panel or between a component that contains or connects said panel to said frame, which can be assembled without additional fasteners.

13. A recycling container of claim 4, where said frame is made of aluminum.

14. A recycling container of claim 12, where said frame final assembly may be for different shapes (round, rectangular).

15. A recycling container of claim 12, where a said panel is removable.

16. A recycling container of claim 12, where said panel may contain an advertisement.

17. A recycling container of claim 12, where said friction material may hold a removable sign.

18. A recycling container of claim 12, where said frame holds a base (bottom) pan.

19. A recycling container of claim 12, where a lid is on top of said frame.

20. A recycling container compromising: a u-channel metal frame, with high durometer “corner” connectors, that in its final configuration can surround a three dimensional space; at least one clear panel, and friction material between said frame and a said panel, and with a base pan, and a lid (cover) on top of said frame with a provision for a sign, and two cam locks connecting the said lid to said frame.
